(19) United States
(12) Patent Application Publication
(10) Pub. No.: US 2022/0272905 A1
(43) Pub. Date: Sep. 1, 2022

(54) EXTENDABLE GARDEN SHEARS

(71) Applicant: HO CHENG GARDEN TOOLS CO., LTD., FU SHING HSIANG (TW)

(72) Inventor: Yao-Chung Huang, FU SHING HSIANG (TW)

(21) Appl. No.: 17/188,662

(22) Filed: Mar. 1, 2021

(51) Int. Cl. A01G 3/025; B25G 1/04

(52) U.S. Cl. CPC A01G 3/0255; B25G 1/04

(57) ABSTRACT

An extendable garden shears includes: an outer tube, an inner tube, a telescopic control set, a cutting structure, a wheel unit and a pull string. Through the combination of the above structure, the shears are extendable without the pull string being directly exposed, and the shears has a cutting structure capable of providing different cutting angles.

### BACKGROUND OF INVENTION

### Field of Invention

The present invention relates to a garden shears, and more particular to an extendable garden shears.

### Description of Related Art

Currently, as shown in FIG. 12, the conventional long-arm shears 70 has an extension rod 71, and one end of the extension rod 71 is provided with an anvil 72. The center of the anvil 72 has a pivot hole 721 and an arc-shaped knife jaw 722 at one side edge extending downward, and a cutting blade 73 is pivoted on one side surface of the anvil 72. A reset spring 74 is installed between the anvil 72 and the blades 73, a force applying arm 731 extending above the cutting blade 73 is connected to a pull string 75, and the pull string 75 passes through a pulley assembly 76 is configured for a user to pull. With the return of the reset spring 74 after the cutting blade 73 is activated, the user can cut the branches and leaves high at high space.

However, the above conventional structure still has following problems in practical applications: the pull string 75 is exposed on the top of the long arm shears 70, so the pull string 75 is easy to hook to branches, leaves or other foreign objects during use, and it takes time to fix the problem, therefore the convenience of use is not good. Also, the extension rod 71 is a fixed structure and cannot be adjusted according to actual needs. Besides, the extension rod 71 is a fixed structure, which causes inconvenience in carrying, and it occupies storage space.

Therefore, it is desirable to provide an extendable garden shears with replaceable nozzles to mitigate and/or obviate the aforementioned problems.

### SUMMARY OF INVENTION

An objective of present invention is to provide an extendable garden shears, which is capable of improving the above-mention problems.

In order to achieve the above mentioned objective, an extendable garden shears has: an outer tube, an inner tube, a telescopic control set, a cutting structure, a wheel unit, and a pull string.

The outer tube and the inner tube are socketed for telescopic movement with each other, the outer tube having a dodge gap and a securing aperture at a top section, the inner tube having a plurality of adjusting apertures lined up on one side and a string aperture on a middle section of another side; the outer tube jacketed with a sliding sleeve having a through slot and a first securing structure.

The telescopic control set has a cover piece secured onto the top section of the outer tube, the cover piece having a through aperture facing the securing aperture and a push button; the push knob has an internal positioning pin and a spring, the spring pushing the positioning pin through the through aperture and the securing aperture and then the positioning pin engages with an adjusting aperture of the inner tube.

The cutting structure is configured for swing movements and has a fixed housing and a movable housing paired together by locking members; the fixed housing further has a connecting section configured for installation on a top end of the inner tube, the movable housing further having a first cutting member pivoted with a second cutting member, the second cutting member provided with a cable passing through the movable housing and connected to the pull string via the wheel unit; a reset spring is connected between the second cutting member and the movable housing; and a plurality of engaging teeth are respectively disposed on corresponding surfaces of the fixed housing and the movable housing, and with engagement of the engaging teeth and the locking member, the movable housing can be adjusted to an angle and locked.

The wheel unit has a first wheel mount installed at an upper section of the inner tube, a second wheel mount and a third wheel mount fixed respectively at a middle and a lower section of the inner tube, and a fourth wheel mount fixed at a bottom section of the outer tube; each wheel mount has at least one a runner accepting the pull string to pass over the first wheel mount, the second wheel mount, the third wheel mount and the fourth wheel mount and then exit at a bottom end of the outer tube, the first wheel mount configured for sliding vertically in the inner tube and combined with a bottom end of the cable.

A fixed end of the pull string is fixed on the cover piece of the telescopic control set, and the pull string is inserted into the outer tube via the dodge gap, passing through the runner of the third wheel mount to enter into the inner tube, passing the runner of the first wheel mount and the runner of the second wheel mount, and then another end of the pull string passes through the string aperture to pass through the through slot and the first securing structure of the sliding sleeve, and then exits form the runner of the fourth wheel mount from the bottom end of the outer tube.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combined drawing of a preferred embodiment according to the present invention.

FIG. 2 is a three-dimensional exploded view of the preferred embodiment according to the present invention.

FIG. 3 is a detail drawing of the cutting structure of the preferred embodiment according to the present invention

FIG. 4 is a three-dimensional combined drawing from another view angle of the preferred embodiment according to the present invention

FIG. 5 is a sectional view of the composition of the preferred embodiment according to the present invention.

FIG. 6 is the state drawing of the first securing structure of the preferred embodiment according to the present invention.

FIG. 7 is an action drawing showing the length adjustment of the preferred embodiment according to the present invention.

FIG. 8 is another action drawing showing the length adjustment of the preferred embodiment according to the present invention.

FIG. 9 shows the head swing movement of the cutting structure of the preferred embodiment according to the present invention.

FIG. 10 is an action drawing while cutting movement is performed of the preferred embodiment according to the present invention.

FIG. 11 is another action drawing while cutting movement is performed of the preferred embodiment according to the present invention.

FIG. 12 is a structure drawing of prior art.

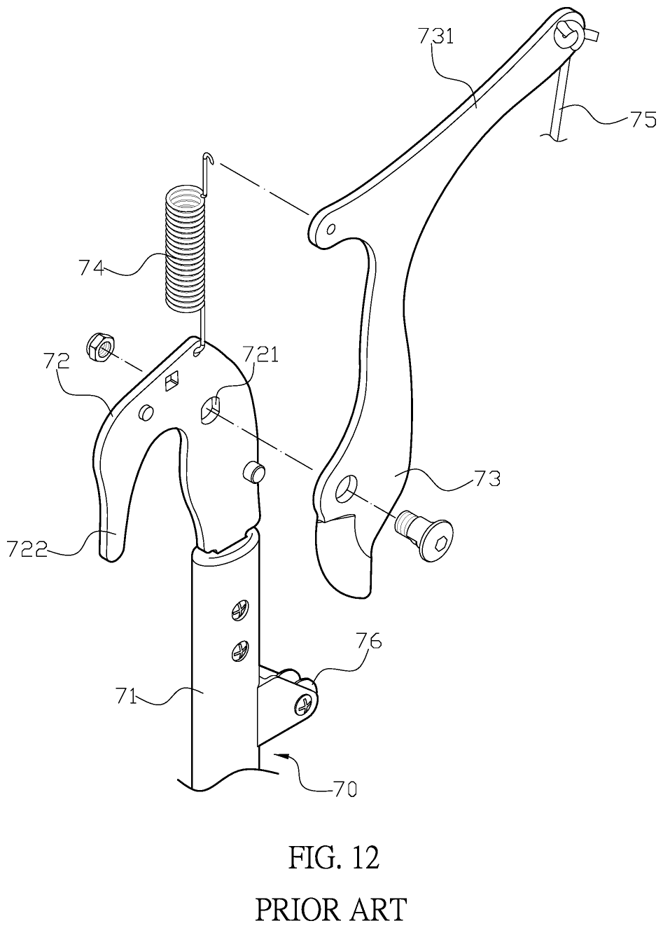

### DETAILED DESCRIPTION OF PREFERRED EMBODIMENT

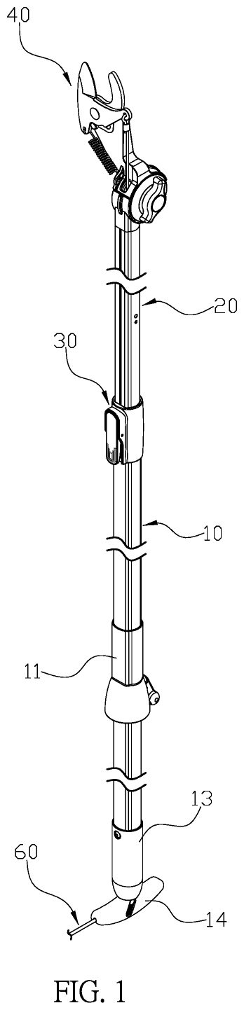

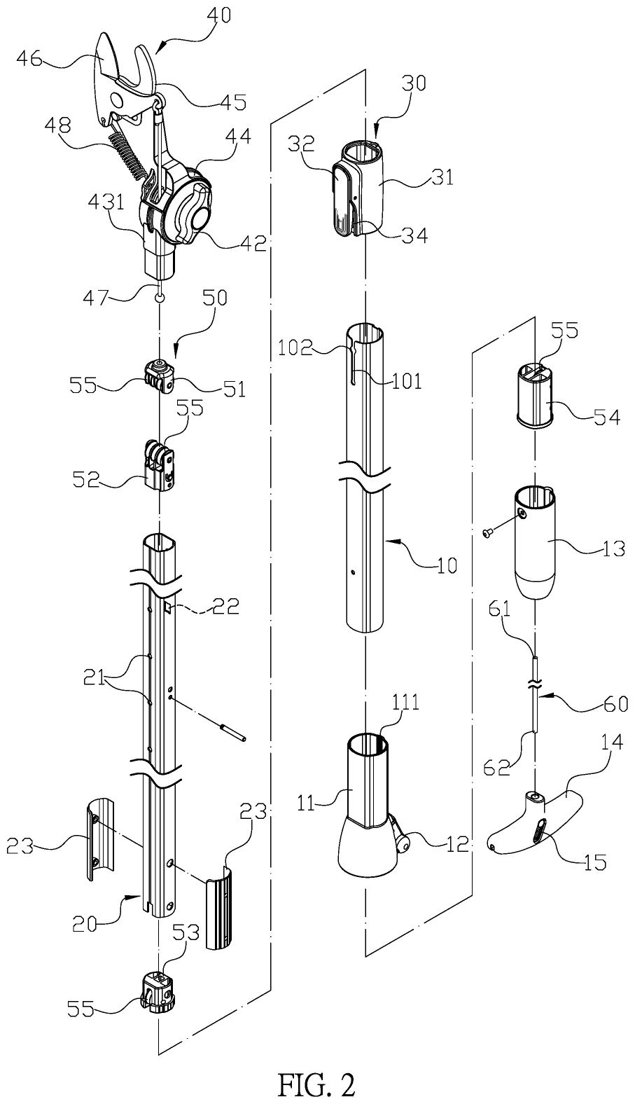

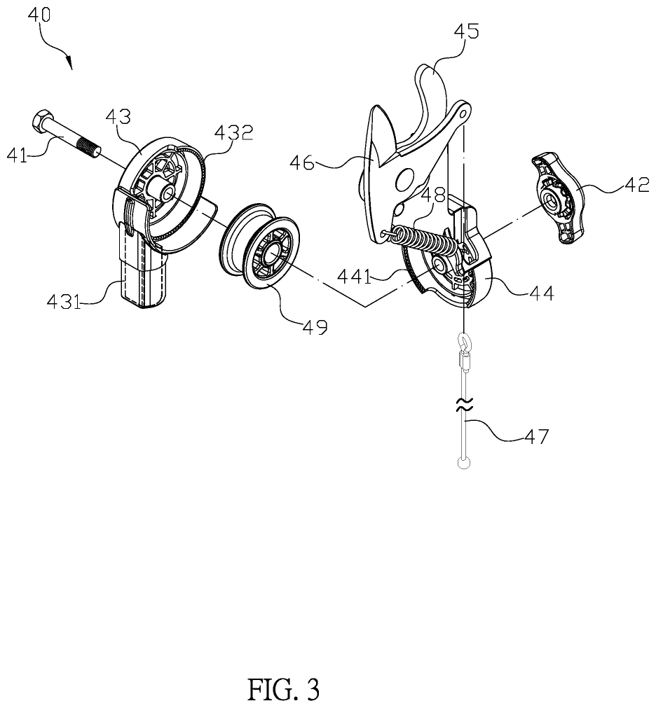

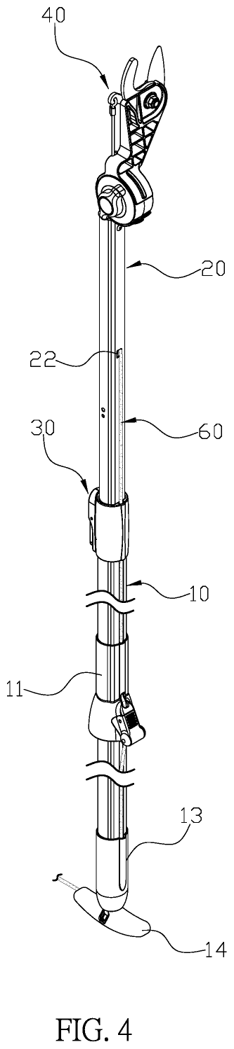

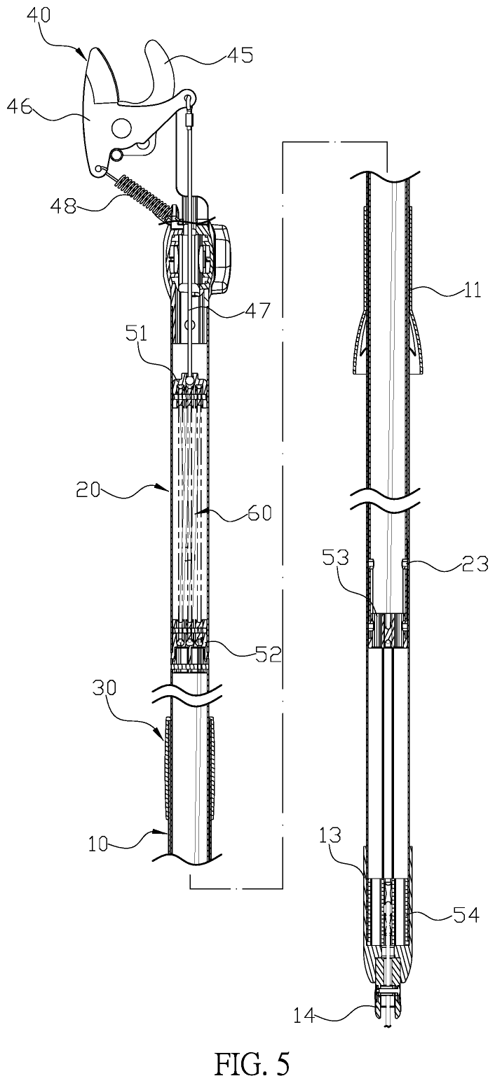

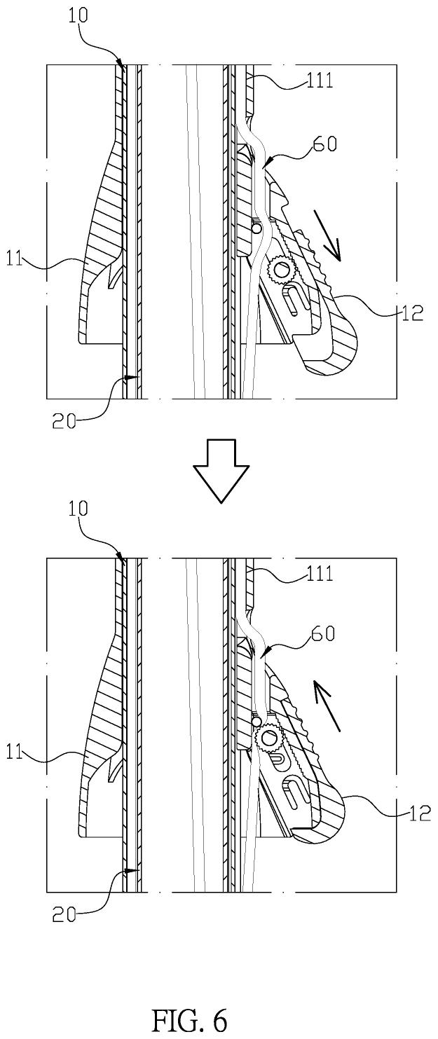

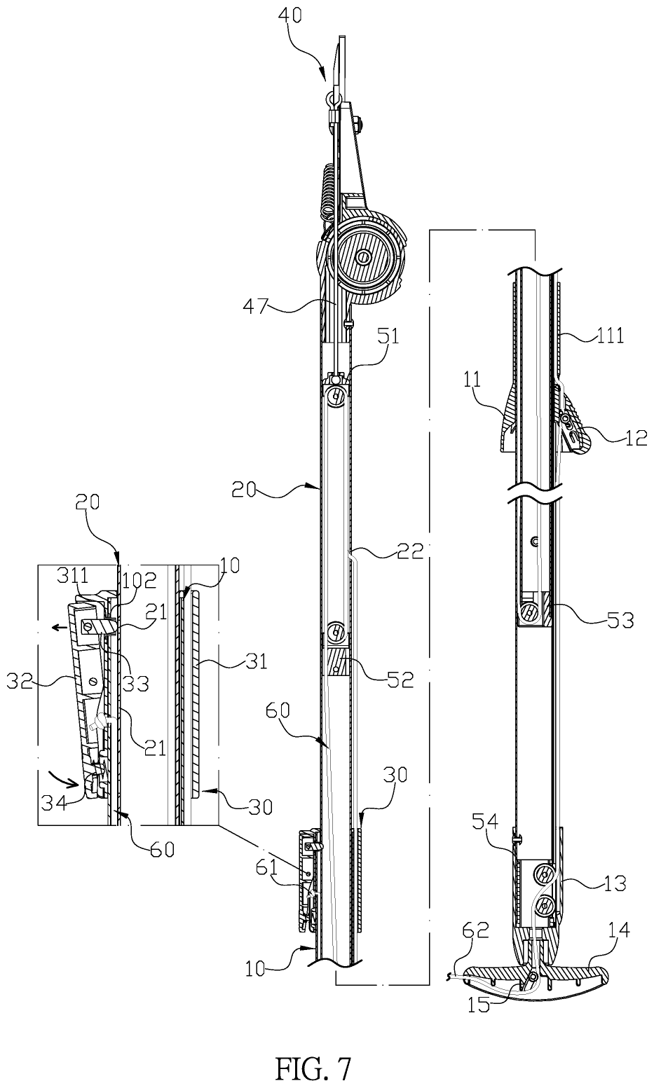

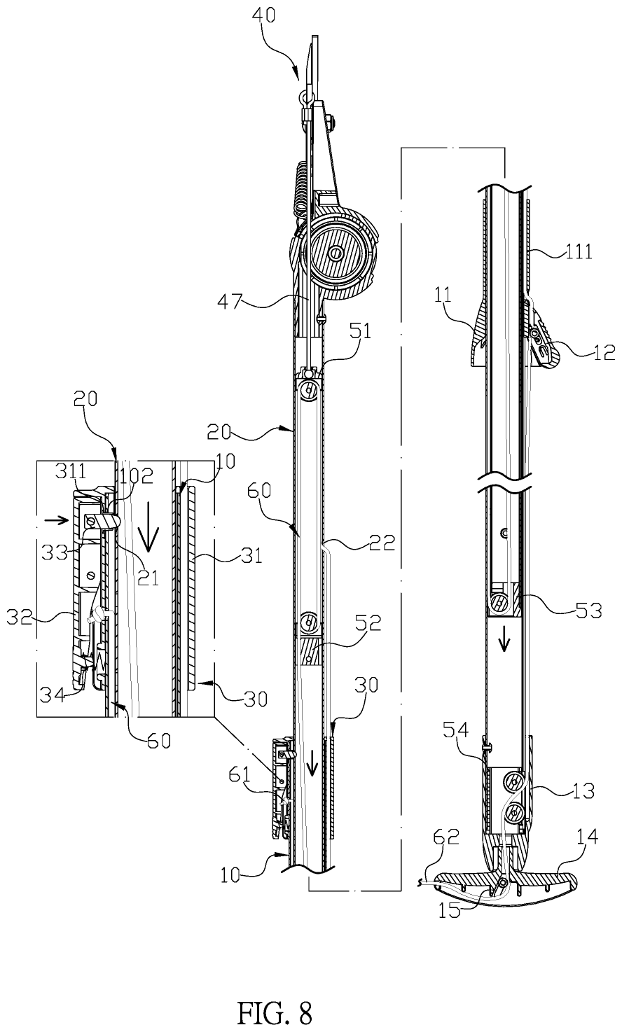

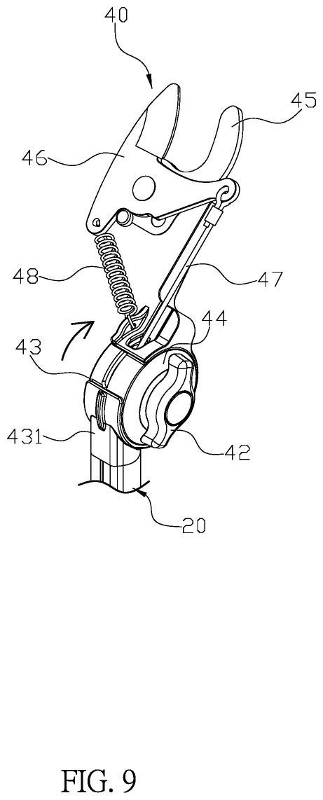

Please refer to FIGS. 1-5. An extendable garden shears comprises: an outer tube 10, an inner tube 20, a telescopic control set 30, a cutting structure 40, a wheel unit 50 and a pull string 60. The outer tube 10 and the inner tube 20 are socketed for telescopic movement with each other, and the outer tube 10 has a dodge gap 101 and a securing aperture 102 at a top section. The inner tube 20 has plurality of adjusting apertures 21 lined up on one side and a string aperture 22 on a middle section of another side. The outer tube 10 is jacketed with a sliding sleeve 11 having a through slot 111 and a first securing structure 12. As shown in FIG. 6, the telescopic control set 30 has a cover piece 31 secured onto the top section of the outer tube 10, and the cover piece has a through aperture 311 facing the securing aperture 102 and a push button 32. The push knob 32 has an internal positioning pin 33 and a spring 34. The spring 34 pushes the positioning pin 33 through the through aperture 311 and the securing aperture 102, and then the positioning pin 33 engages with an adjusting aperture 21 of the inner tube 20, to position the outer tube 10 and the inner tube 20. As shown in FIG. 7 and FIG. 8, the cutting structure 40 is configured for swing movements and has a fixed housing 43 and a movable housing 44 paired together by a screw 41 and a turn screw 42. The fixed housing 43 further has a connecting section 431 is configured for installation on a top end of the inner tube 20, and the movable housing 44 further has a first cutting member 45 pivoted with a second cutting member 46. The second cutting member 46 is provided with a cable 47 passing through the movable housing 44 and connected to the pull string 60 via the wheel unit 50. A reset spring 48 is connected between the second cutting member 46 and the movable housing 44. And a plurality of engaging teeth 432, 441 are respectively disposed on corresponding surfaces of the fixed housing 43 and the movable housing 44. With engagement of the engaging teeth 432, 441 and the turn screw 42, the movable housing 44 can be adjusted to an angle and locked so the cutting structure 40 is fixed at the desired angle, as shown in FIG. 9. The wheel unit 50 has a first wheel 51 mount installed at an upper section of the inner tube 21, a second wheel mount 52 and a third wheel mount 53 fixed respectively at a middle and a lower section of the inner tube 21, and a fourth wheel mount 54 fixed at a bottom section of the outer tube 10. Each wheel mount has at least one a runner 55 accepting the pull string 60 to pass over the first wheel mount 51, the second wheel mount 52, the third wheel mount 53 and the fourth wheel mount 54 and then exit at a bottom end of the outer tube 10. The first wheel mount 51 is configured for sliding vertically in the inner tube 20 and combined with a bottom end of the cable 47. A fixed end 61 of the pull string 60 is fixed on the cover piece 31 of the telescopic control set 30, and the pull string 60 is inserted into the outer tube 10 via the dodge gap 101, passing through the runner 55 of the third wheel mount 53 to enter into the inner tube 20, looped between the runner 55 of the first wheel mount 51 and the runner 55 of the second wheel mount 52, and then another free end 62 of the pull string 60 passes through the string aperture 22 to pass through the through slot 111 and the first securing structure 12 of the sliding sleeve 11, and then exits form the runner 55 of the fourth wheel mount 54 from the bottom end of the outer tube 10. With the above-mentioned configuration, a long-arm shear structure without the pull string 60 directly being exposed, and the long-arm shear has telescopic adjustment ability and the swingable cutting structure 40.

Furthermore, a handle 13 is installed at a bottom end of the outer tube 10.

Moreover, the first securing structure 12 includes two gears and one rack engaging the pull string 60 all together.

Also, a free end of the pull string 60 exiting from the outer tube 10 is connected to a pull bar 14, and the pull bar 14 is provided with a second securing structure 15 for controlling the pull string 60.

In addition, the second securing structure 15 utilizes cooperation of a gear with limited displacement and a rack to engage the pull string 60.

Besides, a lower end of the inner tube 20 is connected to a guiding slider 23 filling in a gap between the inner tube 20 and the outer tube 10.

Also, the locking member is a hand screw cap.

Moreover, the first cutting member 45 is an anvil, and the second cutting member 46 is a blade.

Furthermore, a pulley 49 is installed between the fixed housing 43 and the movable housing 44 of the cutting structure 40, for accepting and positioning the cable 47.

Also, the runners 55 on the first wheel mount 51 and the second wheel mount 52 are 90 degrees off the runners 55 on the third wheel mount 53 and the fourth wheel mount 54.

Additionally, each of the first wheel mount 51 and the second wheel mount 52 has three runners 55 allowing the pull string 60 to loop around the runners 55 of the first wheel mount 51 and the second wheel mount 52 back and forth.

Also, the third wheel mount 53 only has one runner 55, and the fourth wheel mount has two runners 55 stacked with each other, so the pull string 60 passes between the two runner 55 and exits form the bottom end of the outer tube 10.

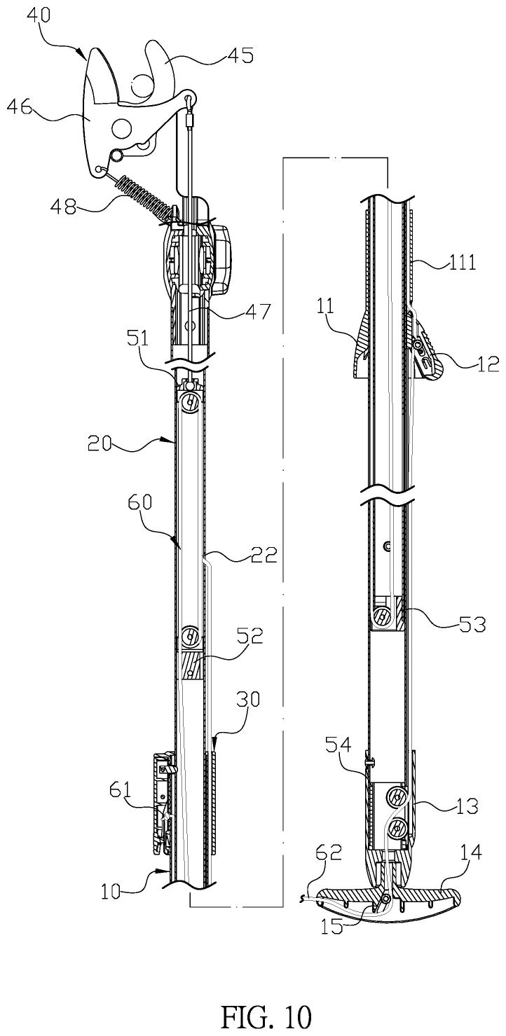

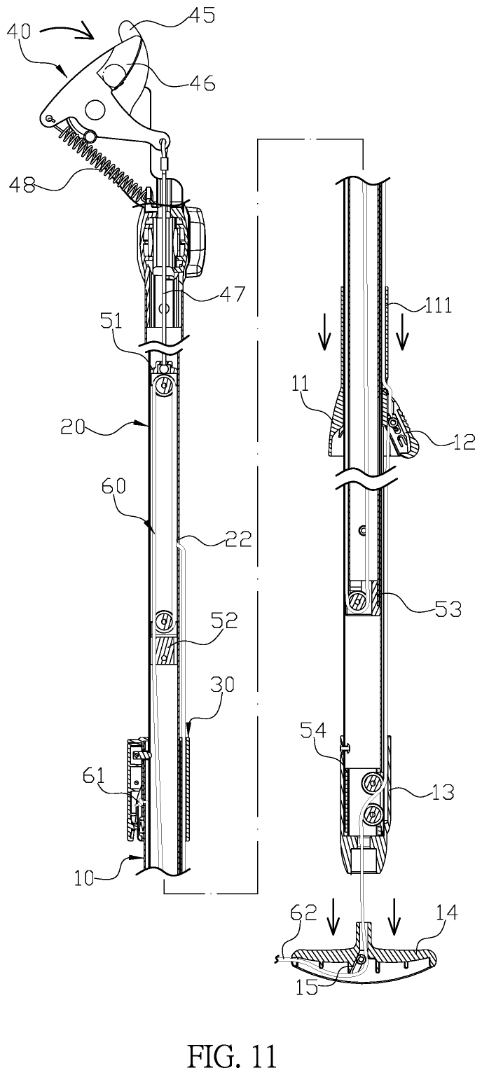

Please refer to FIG. 10 and FIG. 11. In actual use, the pull string 60 is pulled down to drive the first wheel mount 51 and the cable 47 downwardly at the same time, so that the second cutting member 46 can close towards to the first cutting member 45 through the force of pulling to cut off the branches placed between the first cutting member 45 and the second cutting member 46. Furthermore, the pull string 60 is pulled down due to the engagement with the first securing structure 12 and the second securing structure 15, and by the sliding sleeve 11 or the pull handle 14 moving down. Also, by pressing and releasing the push knob 32, the positioning pin 33 is capable of inserting into different adjusting apertures 21 at different heights, and the lengths of the inner tube 20 and the outer tube 10 can be adjusted according to actual needs. with the reset of the first securing structure 12 and the second securing structure 15, after length adjustment of the inner tube 20 and the outer tube 10 After adjusting the length of tubes, the pull string 60 is re-tightened. Moreover, because the cutting structure 40 is capable of being fixed at different angles, it is able to be provide the best cutting angle according to the growth direction of the branches and leaves.

With the structure of the above specific embodiment, the following benefits can be obtained: the pull string 60 is completely hidden and not exposed, so the pull string 60 is free from being hooked to branches and leaves or other foreign objects that need to spend time to eliminate the troubles. Also, the use of the outer tube 10, the inner tube 20 and the telescopic control set 30 in conjunction with the telescopic control set 30 can make the extendable shears to meet the actual needs of gardening work without storage issue. In addition, to the adjustable length, the extendable shears can also have an adjustable cutting structure 40 providing the best cutting angle according to the growth direction of the branches and leaves.

Although the present invention has been explained in relation to its preferred embodiment, it is to be understood that many other possible modifications and variations can be made without departing from the spirit and scope of invention as hereinafter claimed.

What is claimed is:

1. An extendable garden shears comprising: an outer tube, an inner tube, a telescopic control set, a cutting structure, a wheel unit, and a pull string; wherein
the outer tube and the inner tube are socketed for telescopic movement with each other, the outer tube having a dodge gap and a securing aperture at a top section, the inner tube having a plurality of adjusting apertures lined up on one side and a string aperture on a middle section of another side; the outer tube jacketed with a sliding sleeve having a through slot and a first securing structure;
the telescopic control set has a cover piece secured onto the top section of the outer tube, the cover piece having a through aperture facing the securing aperture and a push button; the push knob has an internal positioning pin and a spring, the spring pushing the positioning pin through the through aperture and the securing aperture and then the positioning pin engages with an adjusting aperture of the inner tube;
the cutting structure is configured for swing movements and has a fixed housing and a movable housing paired together by locking members; the fixed housing further has a connecting section configured for installation on a top end of the inner tube, the movable housing further having a first cutting member pivoted with a second cutting member, the second cutting member provided with a cable passing through the movable housing and connected to the pull string via the wheel unit; a reset spring is connected between the second cutting member and the movable housing; and a plurality of engaging teeth are respectively disposed on corresponding surfaces of the fixed housing and the movable housing, and with engagement of the engaging teeth and the locking member, the movable housing can be adjusted to an angle and locked;
the wheel unit has a first wheel mount installed at an upper section of the inner tube, a second wheel mount and a third wheel mount fixed respectively at a middle and a lower section of the inner tube, and a fourth wheel mount fixed at a bottom section of the outer tube; each wheel mount has at least one a runner accepting the pull string to pass over the first wheel mount, the second wheel mount, the third wheel mount and the fourth wheel mount and then exit at a bottom end of the outer tube, the first wheel mount configured for sliding vertically in the inner tube and combined with a bottom end of the cable; and
a fixed end of the pull string is fixed on the cover piece of the telescopic control set, and the pull string is inserted into the outer tube via the dodge gap, passing through the runner of the third wheel mount to enter into the inner tube, passing the runner of the first wheel mount and the runner of the second wheel mount, and then another end of the pull string passes through the string aperture to pass through the through slot and the first securing structure of the sliding sleeve, and then exits form the runner of the fourth wheel mount from the bottom end of the outer tube.

2. The extendable garden shears as claimed in claim 1, wherein a handle is installed at a bottom end of the outer tube.

3. The extendable garden shears as claimed in claim 1, wherein the first securing structure includes two gears and one rack engaging the pull string all together.

4. The extendable garden shears as claimed in claim 1, wherein a free end of the pull string exiting from the outer tube is connected to a pull bar, and the pull bar is provided with a second securing structure for controlling the pull string.

5. The extendable garden shears as claimed in claim 3, wherein the second securing structure utilizes cooperation of a gear with limited displacement and a rack to engage the pull string.

6. The extendable garden shears as claimed in claim 1, wherein a lower end of the inner tube is connected to a guiding slider filling in a gap between the inner tube and the outer tube.

7. The extendable garden shears as claimed in claim 1, wherein the locking member is a hand screw cap.

8. The extendable garden shears as claimed in claim 1, wherein the first cutting member is an anvil, and the second cutting member is a blade.

9. The extendable garden shears as claimed in claim 1, wherein a pulley is installed between the fixed housing and the movable housing of the cutting structure, for accepting the cable.

10. The extendable garden shears as claimed in claim 1, wherein each of the first wheel mount and the second wheel mount has three runners allowing the pull string to loop around the runners of the first wheel mount and the second wheel mount back and forth.

11. The extendable garden shears as claimed in claim 1, wherein the third wheel mount only has one runner, and the fourth wheel mount has two runners stacked with each other.
